(19) United States
(12) Patent Application Publication
(10) Pub. No.: US 2020/0143228 A1
(43) Pub. Date: May 7, 2020

(54) NEURAL NETWORK CONTROL DEVICE AND METHOD

(71) Applicant: ELECTRONICS AND TELECOMMUNICATIONS RESEARCH INSTITUTE, Daejeon (KR)

(72) Inventors: Mi Young LEE, Daejeon (KR); Joo Hyun LEE, Daejeon (KR); Byung Jo KIM, Sejong-si (KR); Ju-Yeob KIM, Daejeon (KR); Jin Kyu KIM, Incheon (KR)

(73) Assignee: ELECTRONICS AND TELECOMMUNICATIONS RESEARCH INSTITUTE, Daejeon (KR)

(21) Appl. No.: 16/541,245

(22) Filed: Aug. 15, 2019

(30) Foreign Application Priority Data
Nov. 5, 2018 (KR) 10-2018-0134727

(51) Int. Cl. G06N 3/04; G06N 3/10

(52) U.S. Cl. CPC G06N 3/04; G06N 3/105

(57) ABSTRACT

An embodiment of the present invention provides a neural network operator that performs a plurality of processes for each of a plurality of layers of a neural network, including: a memory that includes a data-storing space storing a plurality of data for performing the plurality of processes and a synapse code-storing space storing a plurality of descriptors with respect to the plurality of processes; a memory-transmitting processor that obtains the plurality of descriptors and transmits the plurality of data to the neural network operator based on the plurality of descriptors; an embedded instruction processor that obtains the plurality of descriptors from the memory-transmitting processor, transmits a first data set in a first descriptor to the neural network operator based on the first descriptor corresponding to the first process among the plurality of processes, reads a second descriptor corresponding to a second process, which is a next operation of the first process, based on the first descriptor, and controls the memory-transmitting processor to transmit second data corresponding to the second descriptor to the neural network operator based on the second descriptor; and a synapse code generator that generates the plurality of descriptors, and thus it is possible to operate the neural network operator at high speed without interference of other devices, and it is possible to reduce the memory-storing space for the descriptors.

### CROSS-REFERENCE TO RELATED APPLICATION

This application claims priority to and the benefit of Korean Patent Application No. 10-2018-0134727 filed in the Korean Intellectual Property Office on Nov. 5, 2018, the entire contents of which are incorporated herein by reference.

### BACKGROUND OF THE INVENTION

### (a) Field of the Invention

The present invention relates to a device and method for processing a control operation in each of layers of a neural network.

### (b) Description of the Related Art

Neural networks are learned and applied for various purposes (for example, universal object recognition, location recognition, and the like). A convolution neural network (CNN) among the neural networks is widely used for classifying images and finding image positions after obtaining a large number of convolution filters through learning.

Various layers forming the neural network, although their detailed operations are different depending on types thereof, perform common operations, such as a layer setting operation, an input data transmitting operation, a weight transmitting operation, and an output data-storing operation.

The layer setting operation corresponds to a step of setting a necessary control parameter according to characteristics for each layer, and it has various patterns for each layer. For each layer of large capacity weight (540 MB in a case of VGG16), weight data (for example, in a convolution layer, size=(a number of output channels)×(a number of input channels)×(a kernel size)×(a kernel size)) of different size should be transmitted.

In addition, in the case of the input data transmitting step, the sizes (a number of input channels, an input horizontal size, an input vertical size) of the layers are different from each other, and the transmitting pattern varies depending on layer operation characteristics (for example, convolution filter convolution filter kernels, strides, pads).

In addition, the output data-storing step also has different sizes (a number of output channels, an output horizontal size, and an output vertical size) for each layer.

A method in which parameter calculation and control required to step-by-step processing of each layer interferes (for example, setting a layer to a processor, input data size to a processor, calculating a position, transmitting size and position settings to a memory transmitting device, controlling a start of a memory transmitting device, and so on) significantly degrades a neural network operation speed.

When the neural network operation including various layer combinations is performed, the layer setting step, the input data transmitting step, the weight transmitting step, and the output data-storing step are required in common for each layer, and in this case, depending on the layer characteristics, the layer setting pattern, the input data transmitting size and pattern, the weight transmitting size, and the output data size are all different.

In this situation, when the parameters necessary for the operation are calculated for each step, and when the control interferes, the operation speed of the neural network is remarkably decreased.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a neural network control device and method that may solve a delay in operation speed occurring in each processing step for each layer.

An embodiment of the present invention provides a neural network operator that performs a plurality of processes for each of a plurality of layers of a neural network, including: a memory that includes a data-storing space storing a plurality of data for performing the plurality of processes and a synapse code-storing space storing a plurality of descriptors with respect to the plurality of processes; a memory-transmitting processor that obtains the plurality of descriptors and transmits the plurality of data to the neural network operator based on the plurality of descriptors; an embedded instruction processor that obtains the plurality of descriptors from the memory-transmitting processor, transmits a first data set in a first descriptor to the neural network operator based on the first descriptor corresponding to the first process among the plurality of processes, reads a second descriptor corresponding to a second process, which is a next operation of the first process, based on the first descriptor, and controls the memory-transmitting processor to transmit second data corresponding to the second descriptor to the neural network operator based on the second descriptor; and a synapse code generator that generates the plurality of descriptors.

The neural network operator may perform the plurality of processes for each of the plurality of layers using the plurality of data.

When the plurality of processes for the first layer among the plurality of layers are terminated, the synapse code generator may switch an input data space of the data space and an output data space of the data space so as to perform the plurality of processes for a second layer, which is a next layer of the first layer, by using output data of the first layer as an input value.

The synapse code generator may initialize a first channel among channels of the input data in a register of the embedded instruction processor, and may generate an embedded instruction descriptor adding 1 to the register after performing the plurality of processes for the first channel.

The embedded instruction processor may control the memory-transmitting processor so as to obtain the embedded instruction descriptor and transmit pixel values of all channels of the input data to the neural network operator based on the embedded instruction descriptor.

The first descriptor may include address information of the second descriptor.

The embedded instruction processor may control the memory-transmitting processor so as to read address information of the second descriptor from the first descriptor, obtain the second descriptor based on the address information of the second descriptor, and transmit second data corresponding to the second descriptor to the neural network operator.

The plurality of data may include layer setting data, input data, a plurality of weights, and output data, and when each of the plurality of weights is applied to the input data, the synapse code generator may generate descriptors for the remaining weights and the output data.

Another embodiment of the present invention provides a neural network control method that performs a plurality of processes for each of a plurality of layers of a neural network, including: storing a plurality of data that are commonly used to perform the plurality of processes for each of the plurality of layers and are required to perform the plurality of processes; storing a plurality of descriptors related to the plurality of processes; obtaining the plurality of descriptors; transmitting a first data set in a first descriptor based on the first descriptor corresponding to a first process among the plurality of processes; reading a second descriptor corresponding to a second process, which is a next operation of the first process, based on the first descriptor; transmitting second data corresponding to the second descriptor based on the second descriptor; and performing the plurality of processes based on the first data and the second data.

The neural network control method may further include, when the plurality of processes for the first layer among the plurality of layers are terminated, switching an input data space of the data space and an output data space of the data space so as to perform the plurality of processes for a second layer, which is a next layer of the first layer, by using output data of the first layer as an input value.

The neural network control method may further include initializing a first channel among channels of the input data in a register of the embedded instruction processor, and generating an embedded instruction descriptor adding 1 to the register after performing the plurality of processes for the first channel.

The neural network control method may further include obtaining the embedded instruction descriptor, and transmitting pixel values of all channels of the input data to the neural network operator based on the embedded instruction descriptor.

The first descriptor may include address information of the second descriptor.

The neural network control method may further include: reading address information of the second descriptor from the first descriptor; obtaining the second descriptor based on the address information of the second descriptor; and transmitting the second data corresponding to the second descriptor.

The plurality of data may include layer setting data, input data, a plurality of weights, and output data, and the plurality of processes may include a process of setting the layer, a process of reading the input data, a process of setting the weight, and a process of storing the output data.

The neural network control method may further include, when each of the plurality of weights is applied to the input data, generating descriptors for the remaining weights and the output data.

Another embodiment of the present invention provides a neural network control device, including: a neural network operator that sets a layer for each of a plurality of layers of a neural network, obtains input data to be input to the layer, and performs an operation with respect to the plurality of layers based on the input data; a memory that includes a data-storing space storing layer setting data for setting the layer and the input data, and a synapse code-storing space storing a layer-setting descriptor corresponding to an operation for the layer setting and an input data-obtaining descriptor relating to an operation for obtaining the input data; a memory-transmitting processor that obtains the layer-setting descriptor and the input data-obtaining descriptor and transmits the layer setting data and the input data to the neural network operator based on the layer-setting descriptor and the input data-obtaining descriptor; an embedded instruction processor that controls the memory-transmitting processor so as to obtain the layer-setting descriptor and the input data-obtaining descriptor from the memory-transmitting processor, to transmit the layer setting data to the neural network operator based on the layer-setting descriptor, to read the input data-obtaining descriptor based on an address information of the input data-obtaining descriptor included in the layer-setting descriptor, and to transmit the input data to the neural network operator based on the input data-obtaining descriptor; and a synapse code generator that generates the layer-setting descriptor and the input data-obtaining descriptor.

The synapse code generator may initialize a first channel among channels of the input data in a register of the embedded instruction processor, and may generate an embedded instruction descriptor adding 1 to the register after performing weight setting and an output data-storing process for the first channel.

The embedded instruction processor may control the memory-transmitting processor so as to obtain the embedded instruction descriptor and transmit pixel values of all channels of the input data to the neural network operator based on the embedded instruction descriptor.

The data-storing space may store a plurality of weights and output data, and when each of the plurality of weights is applied to the input data, the synapse code generator may generate descriptors for the remaining weights and the output data.

According to the embodiment of the present invention, it is possible to operate at high speed without interference of other devices when processing a series of processes (a layer setting process, an input data transmitting process, a weight transmitting process, and an output data-storing process) of various layers of a neural network.

According to the embodiment of the present invention, an embedded instruction in the descriptor and a dedicated embedded instruction processor for processing the same may generate/store a plurality of descriptors for performing similar processing as one descriptor, and the same descriptor may be variously applied to a value (for example, a y position for input data loading) calculated by the embedded instruction, thus a high compression descriptor synapse code is generated, thereby reducing a memory-storing space for the descriptor.

### BRIEF DESCRIPTION OF THE DRAWINGS

FIG. 1 illustrates a neural network control device according to an embodiment of the present invention.

FIG. 2 illustrates a configuration of a data space of a memory according to an embodiment of the present invention.

FIG. 3 illustrates a convolution neural network according to an embodiment of the present invention.

FIG. 4 illustrates a calculation operation for a convolution layer among layers of a convolution neural network according to an embodiment of the present invention.

FIG. 5 illustrates a flowchart of a process of generating a high-compression synapse code including an embedded instruction according to an embodiment of the present invention.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

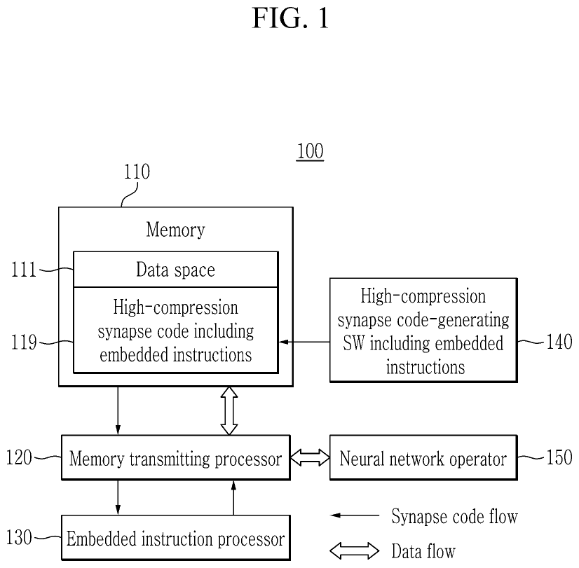

FIG. 1 illustrates a neural network control device according to an embodiment of the present invention.

In FIG. 1, a thin arrow indicates a flow of a high-compression synapse code 119 including embedded instructions, and a thick arrow indicates a flow of data, which is a flow of layer setting data, input data, weight data, and output data.

As shown in FIG. 1, a neural network controller 100 may include a memory 110, a memory-transmitting processor 120, an embedded instruction processor 130, a high-compression synapse code-generating SW 140 including embedded instructions, and a neural network operator 150.

The high-compression synapse code-generating SW 140 including the embedded instructions is software code, and serves to generate linked list descriptors of all layers of the neural network.

The neural network operator 150 may read the high-compression synapse code 119 including the embedded instructions stored in the memory 110, which are generated in the high-compression synapse code-generating SW 140 including the embedded instructions, from the memory-transmitting processor 120 in a linked list manner. When an embedded instruction is included in the read descriptor, the neural network operator 150 may transmit a result of reading the high-compression synapse code 119 to the embedded instruction processor 130.

The memory-transmitting processor 120 may transfer the data included in the memory based on a descriptor input to the memory-transmitting processor 120. For example, the descriptor may include a layer-setting descriptor corresponding to a layer setting step, an input data transmitting descriptor corresponding to an input data transmitting step, a weight-transmitting descriptor corresponding to a weight transmitting step, and an output data-storing descriptor corresponding to an output data-storing step. For example, the memory-transmitting processor 12 may transmit data necessary for layer setting to a necessary place based on information stored in the descriptor by using the layer-setting descriptor.

The descriptor may include a general transmitting descriptor or a 3D transmitting descriptor. The general transmitting descriptor may include a source address, a destination address, n bytes, and a descriptor next address. The 3D transmitting descriptor may include a source address, a destination address, a start x, a start y, a start z, a size x, a size y, a size n, and a descriptor next address.

When the general descriptor is input to the memory-transmitting processor 120, the memory-transmitting processor 120 transmits n bytes of data from a memory location source address to a memory location destination address, and reads the descriptor at a next descriptor location “descriptor next address” to prepare next descriptor processing. For example, the source address or the destination address may include a memory location in the neural network operator 150.

When the 3D transmitting descriptor is input to the memory-transmitting processor 120, the memory-transmitting processor 120 may transmit data of a corresponding size (size x, size y, and size z) from the memory start location (x: horizontal index of data, y: vertical index of data, z: channel index) from the memory location source address to the memory location destination address, and may transmit the data to the descriptor next address corresponding to the descriptor location.

After the data is transmitted to the memory location destination address, the memory-transmitting processor 120 may operate based on a descriptor next address included in each of the descriptors to perform an operation corresponding to the next descriptor based on the descriptor next address.

According to the embodiment of the present invention, the source address, the destination address, and the descriptor next address included in one descriptor may be defined as a linked list. That is, the linked list may mean one in which source address information (which is a memory location where input data is stored), destination address information (which is a memory location where output data is to be stored), and descriptor next address information (which is a descriptor location corresponding to a next operation process) are included in one descriptor. That is, in the linked list, an address where data corresponding to a layer currently being operated is stored, an address where output data is to be stored, and an address where a descriptor corresponding to a next operating step is stored are stored in one descriptor.

The memory 110 may include a data space 111 for storing data. The memory 110 may include the high-compression synapse code 119 including the embedded instructions.

The memory-transmitting processor 120 may read the high-compression synapse code 119 including the embedded instructions from the memory 110, and may sequentially execute descriptors linked by a linked list manner.

The neural network operator 150 may set a first descriptor location of the high-compression synapse code 119 including embedded instructions stored in the memory 110 to the memory-transmitting processor 120, and it may operate the memory-transmitting processor 120 based on the first descriptor location. When the first descriptor location is operated by the neural network operator 150, the memory-transmitting processor 120 may independently obtain the second to n-th descriptor locations from the neural network operator 150 based on the information stored in the first to (n−1)th descriptors. That is, the memory-transmitting processor 120 may sequentially process the memory transmitting processes stored in all the descriptors based on the information described in the first descriptor.

When an embedded instruction is included in the descriptor input to the memory-transmitting processor 120, the embedded instruction processor 130 may interpret the embedded instruction and may process the instruction to output a calculation result. For example, descriptor 0 may be the configuration instruction descriptor r7=0 of the embedded instruction processor 130, descriptor 1 may be a source address, a destination address, start x, r7, start z, size x, size y, size n, a descriptor next address, descriptor 2 may be a set instruction descriptor r7+=1 in the embedded instruction processor 130, the next_address may mean descriptor 1, and after initializing r7 to 0, descriptor 1 is repeatedly executed while increasing r7 by 1 as an example.

The embedded instruction processor 130 may distinguish general descriptors, 3D-transmitting descriptors, and embedded instruction descriptors by using specific bits of the descriptor as op_code. For example, the embedded instruction processor 130 may express the general descriptor using the 00 bits among the upper 2 bits of the descriptor, the 3-D transmitting descriptor using 10 bits, and the embedded instruction descriptor using 11 bits.

For example, the embedded instruction may be a machine language that may be decoded by the embedded instruction processor 130.

The embedded instruction processor 130 may generate an instruction to add the value of register1 (rs1) and the value of register2 (rs2) and then store the added value in register3 (rd), and the generated instruction may be “ADD(ccf, rd, ucf, rs1, rs2) ((0x3 <<28)|(ccf<<25)|(OPC_ADD<<21)|(rd<<16)|(ucf<<15)|(rs1<<10)|(rs2<<5)), OPC_ADD: 0x0”.

The neural network operator 150 may obtain the layer-setting descriptor and the parameter, and may set the layer-setting descriptor and the parameter before the operation process for the layer. The neural network operator 150 may obtain input data and a weight to perform a MAC (multiplier-accumulator) operation.

A detailed operation of the neural network operator 150 may be different for each layer. The neural network operator 150 may transmit the output result to the memory 110 by the output data-storing descriptor.

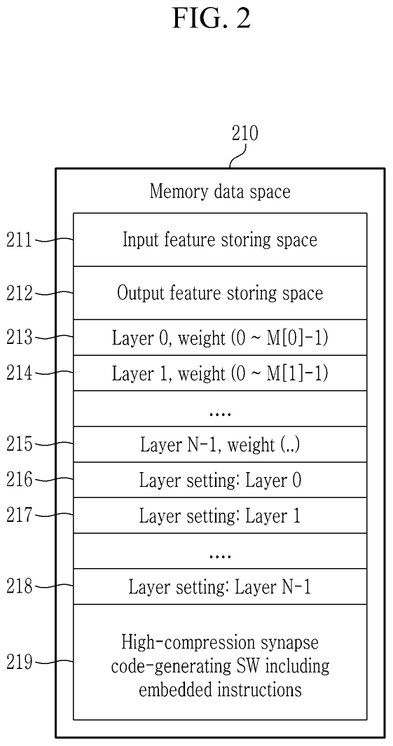

FIG. 2 illustrates a configuration of a data space of a memory according to an embodiment of the present invention.

As shown in FIG. 2, according to an embodiment of the present invention, a memory 210 (the memory 110 of FIG. 1) may include common data areas 211 to 218 all used in a layer setting step, an input data transmitting step, a weight transmitting step, and an output data-storing step that are performed for each layer, and a high-compression synapse code 219 including embedded instructions.

The input data-storing space 211 is a source address area that is an address where data to be transmitted is stored, and the memory-transmitting processor 120 uses the descriptor input therein to transmit data of a corresponding area to a neural network operator (for example, the neural network operator of FIG. 1).

The output data-storing space 212 is a destination address area for storing the transmitted data, and the memory-transmitting processor 120 may store an operation result of the neural network operator 150 in the output data-storing space 212 using the descriptor.

When an operation process for one layer is completed, the input data-storing space 211 and the output data-storing space 212 are toggled, and thus an operation process for the next layer may be performed based on the data stored in the output data-storing space 212 of the previous layer as input data.

The weight areas 213 to 215 may store the weight transmitted to the neural network operator 150 by the descriptors at the weight transmitting step in each layer. The weight areas 213 to 215 include weights for all layers.

The layer setting areas 216 to 218 may include setting parameters transmitted to the neural network operator 150 by the descriptors in the layer setting step. For example, the layer settings areas 216 to 218 may include a kernel size, a stride, and a pad of a corresponding layer, and includes all layer settings.

The weight areas 213 to 215 and the layer setting areas 216 to 218 are one data group for use in all the layers, and the memory-transmitting processor 120 does not use different descriptors for each layer, and it may transmit the weight areas 213 to 215 and the layer setting areas 216 to 218 set by one descriptor to the neural network operator 150.

The high-compression synapse code 119 including the embedded instructions may store the descriptor synapse code generated in the high-compression synapse code-generating SW 140 including the embedded instructions.

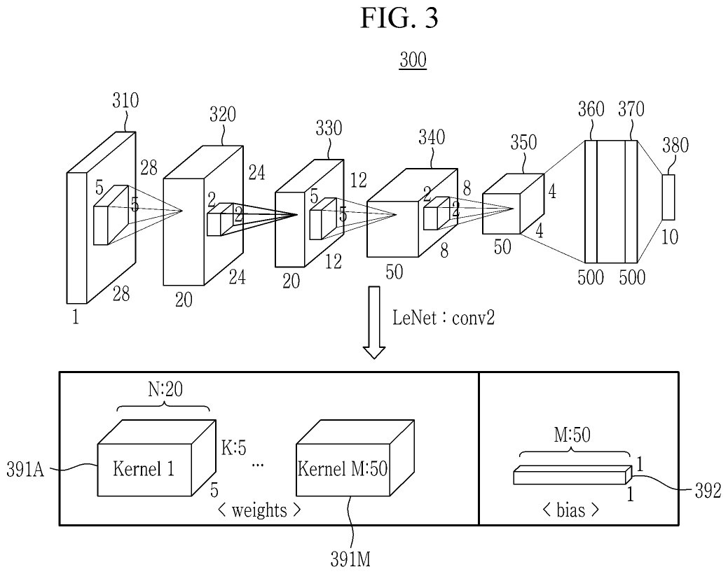

FIG. 3 illustrates a convolution neural network according to an embodiment of the present invention.

As shown in FIG. 3, a convolution neural network 300 according to the embodiment of the present invention has a LeNet structure.

The convolution neural network 300 may include a plurality of convolution layers 310 and 330 including a plurality of convolution filters. For example, convolution kernels of 20×5×5 channels among data of 1×28×28 channels of the first convolution layer 310 synthesized first to input data among the plurality of convolution layers may correspond to 1×1×1 pooling data of data of 20×24×24 channels of the first pulling layer 320 receiving the convolution kernel from the first convolution layer 310 among the plurality of pooling layers. For example, 20×5×5 data of 20×12×12 channels of the second convolution layer 330 may correspond to pooling data of a 1×1×1 channel among data of 50×8×8 channels of the second pooling layer 340 receiving the convolution kernel from the second convolution layer 330 among a plurality of pooling layers.

The convolution neural network 300 may include a plurality of pooling layers 320 and 340 for performing a sub-sampling function. For example, pooling data of 20×2×2 channels among the 20×24×24 channels of the first pooling layer 320 may correspond to a convolution kernel of a 1×1×1 channel among 20×12×12 channels of the second convolution layer 330 receiving pooling data from the first pooling layer 320 among the plurality of convolution layers. For example, pooling data of 50×2×2 channels among data of 50×8×8 channels of the second pooling layer 340 may correspond to inner-product FCL data of a 1×1×1 channel among data of 50×4×4 channels of an inner-product FCL 350.

The convolution neural network 300 may include the inner-product fully connected layer (FCL) 350 for performing the classification function. A size of the inner-product FCL 350 may be 50×4×4. For example, all the data of the 50×4×4 channel of the inner-product FCL 350 may correspond to data of one channel of a plurality of ReLU1 layers 360 and 370.

The convolution neural network 300 may include the plurality of ReLU1 layers 360 and 370 that are responsible for an activation function. A width of the ReLU1 layers 360 and 370 may be 500.

The convolution neural network 300 may include a batch normalization layer 380 that performs a normalization function. A width of the batch normalization layer 380 may be 10.

For example, the second convolution layer 330 may be divided into weight data 391A and 391M and bias data 392. The weight data may include M unit weight data corresponding to M kernels from kernel 1 391A to kernel M 391M, and the bias data may include M unit biases.

A size of the unit weight data may be N×K×K, and a size of the unit bias data may be 1×1×1. Herein, N may be the width of the second convolution layer 330, and N may be 20. Herein, M may be the width of the second pulling layer 340, which is the next layer of the second convolution layer 330, and M may be 50. Herein, K may be the number of horizontal or vertical channels of a convolution kernel set of the second convolution layer 330 corresponding to data of one channel of the second pulling layer 340, and K may be 5.

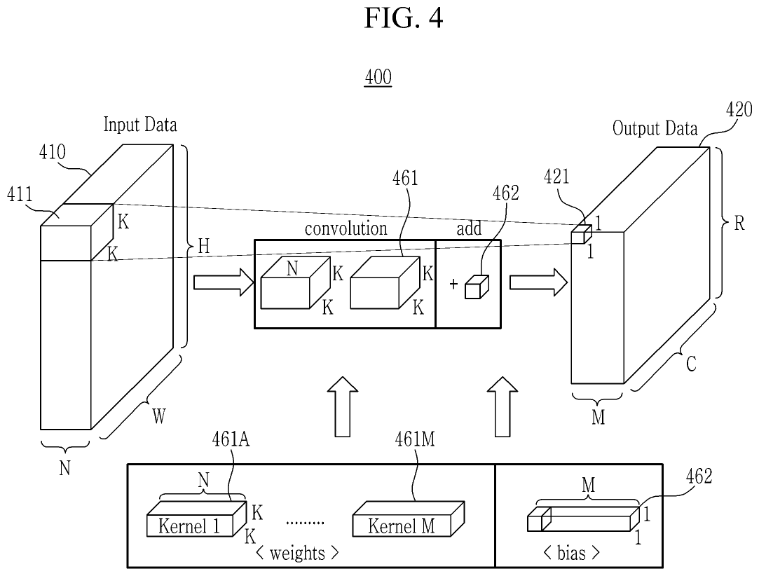

FIG. 4 illustrates a calculation operation for a convolution layer among layers of a convolution neural network according to an embodiment of the present invention.

As shown in FIG. 4, according to the embodiment of the present invention, the neural network operator 150 may perform convolution (multiplying the input data and the weights thereof and adding the multiplied values) of input data 411 of the N×K×K size of the first horizontal line (first channel) of the first vertical line among input data 410 and M weights 461A and 461M of N×K×K size.

Then, after the convolution process, the neural network operator 150 may add M bias values 462 of a 1×1×1 size to calculate M output values 421 of a 1×1×1 size of the first channel among output data 420.

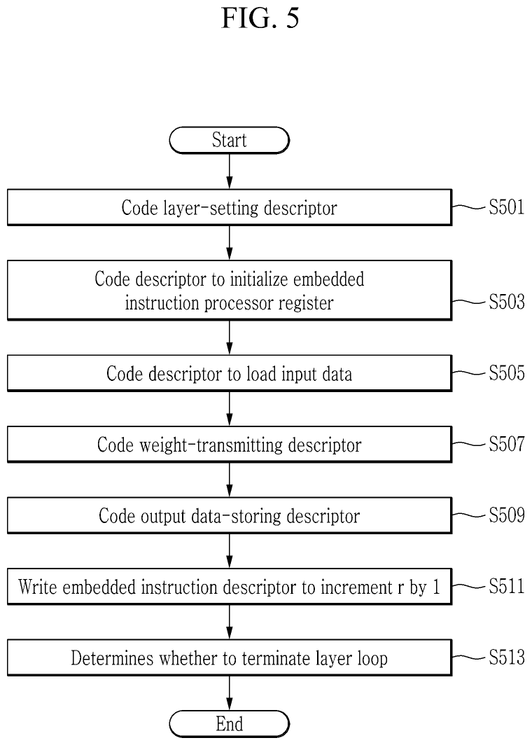

FIG. 5 illustrates a flowchart of a process of generating a high-compression synapse code including an embedded instruction according to an embodiment of the present invention.

In the embodiment described above, it is assumed that corresponding data is preloaded in each of the remaining data areas 211 to 218 (the input data-storing space, the output data-storing space, the weight space, and the layer setting space) excluding the area of the high-compression synapse code 219 including the embedded instructions in FIG. 2. It is also assumed that the neural network operator 150 previously knows the storage locations of the respective kernels of each weight through a previously stored table. It is assumed that the storage locations of all layer settings are known in advance through the table.

For example, a case in which the input data loading horizontal line unit is 19 lines and the output data-storing horizontal line unit is 19 lines will be exemplarily described below. The neural network controller 100 may process an operation for 19 horizontal lines at a time and repeat the operation 19 times in a vertical line direction.

As shown in FIG. 5, the neural network controller 100 may code the layer-setting descriptor (S501). For example, the neural network controller 100 sets the storage location of the layer setting in the memory 110 to the source address and the address of the neural network operator 150 to which the layer setting contents will be transmitted to the destination address, and it generates the descriptors to be transmitted by as much as the input data size and then sets the address of the register corresponding to the next operation to the descriptor next address.

Then, the neural network controller 100 may code a descriptor to initialize an embedded instruction processor registers (S503). For example, the neural network controller 100 may initialize a register for the embedded instruction processor to be used as an r position in the vertical direction to zero. Then, the neural network controller 100 may initialize R=19 in the register to check a termination condition of r. For example, when the register 7 of the embedded instruction processor is to be set to 0, the neural network controller 100 may store r=r7=0 so that it may be represented by a machine language and stored as an embedded instruction descriptor. Then, the neural network controller 100 may initialize the vertical position if_r of the input data to zero in the embedded instruction processor register. The neural network controller 100 may then initialize if_step to 5 in the embedded instruction register so that the input data may be loaded for r of every 5 lines.

The neural network controller 100 may then code the descriptor to load the input data (S505). For example, the neural network controller 100 may code the embedded instruction descriptor so that the input data loading descriptor coding may be performed when the register values of if_r and r are the same. When the register values of if_r and r are different, the neural network controller 100 may code the embedded instruction descriptor so that they may be bypassed. The input data loading descriptor may be coded as “source address=memory input data address, destination address=memory address of neural network operator, start x=0, start y=if_r, start z=0, size x=19, size y=5+(kernel size−stride size), size z=64”. When the input data loading is performed, the neural network controller 100 may update if_r to a next input data loading position. For example, the neural network controller 100 may code the embedded instruction descriptor to be updated to If_r⁺=if_step.

The neural network controller 100 may then code the weight-transmitting descriptor (S507). Hereinafter, it is assumed that the neural network controller 100 knows storage addresses and sizes with respect to weights of all kernels of each layer through a table. For example, the neural network controller 100 may sequentially generate weight-transmitting descriptors such as a load weight #0 descriptor. In a case of a sparse weight, the neural network controller 100 may code the descriptors in a CSR manner to form a pair of only non-zero weights and sparse indexes. For example, the neural network controller 100 may store all the weights in order. The weight-transmitting descriptor is equal to “source address=weight address of memory, destination address=memory address of neural network operator, nbytes of corresponding weight, descriptor next address”.

The neural network controller 100 may then code the output data-storing descriptor (S509). For example, the neural network controller 100 may perform output data-storing descriptor coding for the number of output kernels to which the output is desired (in the case of FIG. 2, 32 output kernels are provided as a unit), and then generate the output data-storing descriptor. For example, the output data-storing descriptor is “source address=output data address of memory, destination address=output memory address of neural network operator, start x=0, start y=r (initial=0), start z=(0, 32, 64), size x=19, size y=1, size z=32”. The “start_z” designates the desired “start z” in the SW code. The neural network controller 100 may then repeatedly generate the weight-transmitting descriptor and the output data-storing descriptor coding until all kernels are processed.

Next, the neural network controller 100 may write the embedded instruction descriptor to increment r by one to repeat the embedded register update and loop end determination operations on the other vertical lines (S511). For example, the neural network controller 100 checks whether r<R is satisfied as a termination condition, and when the condition is satisfied, the next descriptor address is set to if_descrpt_addr such that the previous steps are performed again, while when the condition is not satisfied, the next descriptor address is set to the next descriptor address and the coding of the corresponding layer is terminated.

When the condition is checked and r<R is satisfied, the neural network controller 100 returns the next descriptor address to if_descrpt_addr and repeats the process corresponding to the descriptor. When r is updated by 1, the neural network controller 100 applies input data loading (performed only when r=if_r) and output data loading operations differently. The output data-storing descriptor is “source address=input data address of memory, destination address=output memory address of neural network operator, start x=0, start y=r (1, 2, 3, . . . , R−1), start z=(0, 32, 64 . . . ), size x=19, size y=1, size z=32”.

Finally, the neural network controller 100 determines whether the coding of all layers has been completed, and based on the result, determines whether to proceed to the next layer coding or to terminate (S513).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A neural network control device comprising:
a neural network operator that performs a plurality of processes for each of a plurality of layers of a neural network;
a memory that includes a data-storing space storing a plurality of data for performing the plurality of processes and a synapse code-storing space storing a plurality of descriptors with respect to the plurality of processes;
a memory-transmitting processor that obtains the plurality of descriptors and transmits the plurality of data to the neural network operator based on the plurality of descriptors;
an embedded instruction processor that obtains the plurality of descriptors from the memory-transmitting processor, transmits a first data set in a first descriptor to the neural network operator based on the first descriptor corresponding to the first process among the plurality of processes, reads a second descriptor corresponding to a second process, which is a next operation of the first process, based on the first descriptor, and controls the memory-transmitting processor to transmit second data corresponding to the second descriptor to the neural network operator based on the second descriptor; and
a synapse code generator that generates the plurality of descriptors.

2. The neural network control device of claim 1, wherein
the neural network operator performs the plurality of processes for each of the plurality of layers using the plurality of data.

3. The neural network control device of claim 1, wherein
when the plurality of processes for the first layer among the plurality of layers are terminated, the synapse code generator switches an input data space of the data space and an output data space of the data space so as to perform the plurality of processes for a second layer, which is a next layer of the first layer, by using output data of the first layer as an input value.

4. The neural network control device of claim 3, wherein
the synapse code generator initializes a first channel among channels of the input data in a register of the embedded instruction processor, and generates an embedded instruction descriptor adding 1 to the register after performing the plurality of processes for the first channel.

5. The neural network control device of claim 4, wherein
the embedded instruction processor controls the memory-transmitting processor so as to obtain the embedded instruction descriptor and transmit pixel values of all channels of the input data to the neural network operator based on the embedded instruction descriptor.

6. The neural network control device of claim 1, wherein
the first descriptor includes address information of the second descriptor.

7. The neural network control device of claim 6, wherein
the embedded instruction processor controls the memory-transmitting processor so as to read address information of the second descriptor from the first descriptor, obtain the second descriptor based on the address information of the second descriptor, and transmit second data corresponding to the second descriptor to the neural network operator.

8. The neural network control device of claim 1, wherein
the plurality of data include layer setting data, input data, a plurality of weights, and output data, and
when each of the plurality of weights is applied to the input data, the synapse code generator generates descriptors for the remaining weights and the output data.

9. A neural network control method that performs a plurality of processes for each of a plurality of layers of a neural network, comprising:
storing a plurality of data that are commonly used to perform the plurality of processes for each of the plurality of layers and are required to perform the plurality of processes;
storing a plurality of descriptors related to the plurality of processes;
obtaining the plurality of descriptors;
transmitting a first data set in a first descriptor based on the first descriptor corresponding to a first process among the plurality of processes;
reading a second descriptor corresponding to a second process, which is a next operation of the first process, based on the first descriptor;
transmitting second data corresponding to the second descriptor based on the second descriptor; and
performing the plurality of processes based on the first data and the second data.

10. The neural network control method of claim 9, further comprising,
when the plurality of processes for the first layer among the plurality of layers are terminated, switching an input data space of the data space and an output data space of the data space so as to perform the plurality of processes for a second layer, which is a next layer of the first layer, by using output data of the first layer as an input value.

11. The neural network control method of claim 10, further comprising
initializing a first channel among channels of the input data in a register of the embedded instruction processor, and generating an embedded instruction descriptor adding 1 to the register after performing the plurality of processes for the first channel.

12. The neural network control method of claim 11, further comprising:
obtaining the embedded instruction descriptor; and
transmitting pixel values of all channels of the input data to the neural network operator based on the embedded instruction descriptor.

13. The neural network control method of claim 9, wherein
the first descriptor includes address information of the second descriptor.

14. The neural network control method of claim 13, further comprising:
reading address information of the second descriptor from the first descriptor;
obtaining the second descriptor based on the address information of the second descriptor; and
transmitting the second data corresponding to the second descriptor.

15. The neural network control method of claim 9, wherein
the plurality of data include layer setting data, input data, a plurality of weights, and output data, and
the plurality of processes include a process of setting the layer, a process of reading the input data, a process of setting the weight, and a process of storing the output data.

16. The neural network control method of claim 15, further comprising,
when each of the plurality of weights is applied to the input data, generating descriptors for the remaining weights and the output data.

17. A neural network control device, comprising:
a neural network operator that sets a layer for each of a plurality of layers of a neural network, obtains input data to be input to the layer, and performs an operation with respect to the plurality of layers based on the input data;
a memory that includes a data-storing space storing layer setting data for setting the layer and the input data, and a synapse code-storing space storing a layer-setting descriptor corresponding to an operation for the layer setting and an input data-obtaining descriptor relating to an operation for obtaining the input data;
a memory-transmitting processor that obtains the layer-setting descriptor and the input data-obtaining descriptor and transmits the layer setting data and the input data to the neural network operator based on the layer-setting descriptor and the input data-obtaining descriptor;
an embedded instruction processor that controls the memory-transmitting processor so as to obtain the layer-setting descriptor and the input data-obtaining descriptor from the memory-transmitting processor, to transmit the layer setting data to the neural network operator based on the layer-setting descriptor, to read the input data-obtaining descriptor based on an address information of the input data-obtaining descriptor included in the layer-setting descriptor, and to transmit the input data to the neural network operator based on the input data-obtaining descriptor; and
a synapse code generator that generates the layer-setting descriptor and the input data-obtaining descriptor.

18. The neural network control device of claim 17, wherein
the synapse code generator initializes a first channel among channels of the input data in a register of the embedded instruction processor, and generates an embedded instruction descriptor adding 1 to the register after performing weight setting and an output data-storing process for the first channel.

19. The neural network control device of claim 18, wherein
the embedded instruction processor controls the memory-transmitting processor so as to obtain the embedded instruction descriptor and transmit pixel values of all channels of the input data to the neural network operator based on the embedded instruction descriptor.

20. The neural network control device of claim 17, wherein
the data-storing space stores a plurality of weights and output data, and
when each of the plurality of weights is applied to the input data, the synapse code generator generates descriptors for the remaining weights and the output data.
